(19) United States
(12) Patent Application Publication
(10) Pub. No.: US 2005/0282123 A1
(43) Pub. Date: Dec. 22, 2005

(54) Universal numeration system

(76) Inventor: Alexander Trubnikov, Omaha, NE (US)

Correspondence Address: Alexander Trubnikov, 11251 Bauman Ave., Omaha, NE, 68164, US

(21) Appl. No.: 10/872,535

(22) Filed: Jun. 22, 2004

(51) Int. Cl. G09B 19/02

(52) U.S. Cl. 434/189

(57) ABSTRACT

The proposed Universal Numeration System (U.N.S.) offers a new principled version of utilization. Flexibility and universality of this system is considered to be one of the new principles and enhancements in our life and all we stand for. Compactness and comprehension of numerals may be just one of the availabilities that this Universal Numeration System (U.N.S.) allows. Compressing zeroes by using a repetitive symbol simplifies construction of the required amount of [multiplied] zeroes. Finally, speedwriting associated with conjunctions allows one to produce numerals in any combination and direction.

### BACKGROUND OF THE INVENTION

The original idea came from the need of writing more conveniently by creating a new numeration system. Stepping into the twenty-first century brings its own voice into the heritage of the world's history in developing future civilizations that include a unique numeration system which is capable of uniting cultures and people.

### BRIEF SUMMARY OF THE INVENTION

The Universal Numeration System that is being currently introduced allows one to utilize the invented numerals and symbols for a simplified version in speedwriting of numbers for various everyday tasks. The main key is a possibility of contiguous writing numerals and symbols, and as a result, a more efficient and convenient use of time on diversely angled levels which today's and in the future-to-come society needs. Some of these advantages include the appearance, convenience, and the compact state using symbols (compressing zeroes into a shorter version by a simple shorthand symbol), speedwriting, and the way writing is used in real life. The attachments represent large numbers in value by symbolizing random numerals using the same concept of scientific notation. The only fallback is that the human mind has not yet been adjusted to the new form of display and conception of this aspect.

### BRIEF DESCRIPTION OF THE SEVERAL VIEWS OF THE DRAWING

FIG. 1

Examples of various numerical systems in history

FIG. 2

A version of numbers in print from zero though nine and the number ten

FIG. 3

Disjointed version of numbers in cursive from zero through nine and the number ten

FIG. 4

Conjoined version of numbers in forward and backward order

FIG. 5 [sections]

Homology of the number “5” relatively to itself

FIG. 6 [sections]

Homology of neighboring numerals toward the number “5” (Numbers “3” and “4” (before “5”) have a lower loop and numbers “6” and “7” (after “5”) have an upper loop)

FIG. 7 [sections]

Numbers relative to each other

FIG. 8 [sections]

Conjoined numbers divided into logical groups

FIG. 9

Auxiliary (reduced) numbers—predetermined for utilization in various individual incidents

FIG. 10

Numerical attachments (half-sized symbols)—predetermined for representing the ten different place values

FIG. 11

Ordinal number

FIG. 12

Symbol used for repetition of zeroes in numbers

FIG. 13

Abstract comprehension of numerical significance according to ten different place values

FIG. 14

Symbol utilized for an exponent

FIG. 15

Additional symbols—predetermined for representing special meaning

FIG. 16

Symbol of a phone number

FIG. 17

Symbol of currency

FIG. 18

Symbol of time

FIG. 19

Symbol of a power

FIG. 20

Symbol of a percent

FIG. 21

Symbol of a degree

FIG. 22

Symbol of a decimal point

FIG. 23

Symbol of a fraction

FIG. 24

Page indicator

FIG. 25

A symbol of repetitive zeroes (and their quantity) before and after “1”

FIG. 26

Utilization of a number to a certain power

FIG. 27

Utilization of an exponent

FIG. 28

Utilization of a decimal point

FIG. 29

Utilization of a zero before a number

FIG. 30

Example of writing “0” (zero) for counting and utilization in account numbers (invoices, banks, etc.)

FIG. 31

Utilization of symbols from ten through one billion

FIG. 32 [auxiliary symbol]

Symbol applied for designation of a degree

FIG. 33 [auxiliary symbol]

Symbol applied for designation of a percent

FIG. 34 [auxiliary symbol

Symbol applied for designation of a decimal point between numbers

FIG. 35 [auxiliary symbol]

Symbol applied for designation of a fraction

FIG. 36 [auxiliary symbol]

Symbol applied for designation of a number to a certain power

FIG. 37 [auxiliary symbol]

Symbol applied for designation of a currency (dollars & cents)

FIG. 38 [auxiliary symbol]

Symbol applied for designation of a telephone number

FIG. 39 [auxiliary symbol]

Symbol applied for designation of precise morning hour (A.M.)

FIG. 40 [auxiliary symbol]

Symbol applied for designation of precise afternoon hour (P.M.)

FIG. 41 [auxiliary symbol]

Symbol applied for designation of morning hours and minutes

FIG. 42 [auxiliary symbol]

Symbol applied for designation of afternoon hours and minutes

FIG. 43 [auxiliary symbol]

Symbol applied for designation of an ordinal number

FIG. 44 [auxiliary symbol]

Symbol applied for designation of a page indicator

FIG. 45

New version of numbers corresponding to a generally accepted numeration

FIG. 46

FULL-SIZED numbers—predetermined for fast conjoint writing of numbers. (The connection is realized by means of prolonging connective line to the right and upward to a smooth combination with the next figure in any order.)

FIG. 47

NUMERICAL ATTACHMENTS (half-sized symbols)—predetermined for representing the ten different place values

FIG. 48

AUXILIARY (reduced) numbers

Predetermined for utilization in various individual incidents

FIG. 49

ADDITIONAL symbols—predetermined for representing special meaning

FIG. 50

Designation of a TELEPHONE NUMBER by means of a straight long line between full-sized numbers

FIG. 51

Designation of a POWER by means of a short wavy line with auxiliary numbers at the end

FIG. 52

Designation of a DECIMAL POINT by means of a corresponding additional sign (with auxiliary numbers representing the quantity of zeroes if such exists) with the following full-sized numbers

FIG. 53

Designation of a FRACTION by means of a corresponding additional sign between two auxiliary numbers

FIG. 54

Designation of a DEGREE by means of a short line to the left from the number

FIG. 55

Designation of a PERCENTAGE by means of a short line to the right from the number

FIG. 56

Designation of an INDICATOR by means of a short line to the left and at the bottom beside the number

FIG. 57 Designation of TIME by means of a long wavy line with full-sized numbers for the daytime (A.M.) at the end representing minutes

FIG. 58

Designation of TIME by means of a long wavy line with auxiliary numbers for the nighttime (P.M.) at the end representing minutes

FIG. 59

Designation of a PECUNIARY SUM by means of a straight, long line with auxiliary numbers at the end representing the quantity of cents

FIG. 60

Designation of an ORDINAL number by means of a corresponding additional sign to the right of the number

FIG. 61

The number TEN is formed by means of connecting full-sized “ones” and “zeroes” on the right—(Varying utilization of zeroes in the next table)

FIG. 62

Designation of the numerical attachment represented as the place value “HUNDRED”—written as a half-sized symbol in the middle and/or at the end of a number

FIG. 63

Designations of the numerical attachment represented as the place value “THOUSAND”—written as a half-sized symbol in the middle and/or at the end of a number

FIG. 64

Designation of the numerical attachment represented as the place value “TEN THOUSAND”—written as a half-sized symbol in the middle and/or at the end of a number

FIG. 65

Designation of the numerical attachment represented as the place value “HUNDRED THOUSAND”—written as a half-sized symbol in the middle and/or at the end of a number

FIG. 66

Designation of the numerical attachment represented as the place value “MILLION”—written as a half-sized symbol in the middle and/or at the end of a number

FIG. 67

Designation of the numerical attachment represented as the place value “BILLION”—written as a half-sized symbol in the middle and/or at the end of a number

FIG. 68, 69

Designation of the numerical attachments represented as the place values “TRILLION and MORE”—written as a half-sized symbol exponent at the end of a number, in which the significance of a power is specified with the auxiliary numbers

FIG. 70

SMALL numerical attachments utilized only with auxiliary numbers following an exponent

FIG. 71

Abstract comprehension of the numerical significance according to the ten different place values: ten, hundred, thousand, ten thousand, hundred thousand, million, billion, and the exponent

FIG. 72

Symbol used for repetition of zeroes in numbers

FIG. 73

Method used for repetition of zeroes in numbers realized by adding to the repetitive symbol to its quantity with the auxiliary numbers

FIG. 74

Literal designation of zeroes—realized only for calculation also in independent numerals from 10 to 90—(written as a clockwise half-sized symbol)

FIG. 75

The numerical attachment “100”

FIG. 76

The numerical attachment “1,000,000”

FIG. 77

Symbol of zero in the singular variant

FIG. 78

Symbol of zero in the plural variant

FIG. 79

Table of numbers from 0 to 100 in the New Numeration System

FIG. 80, 81

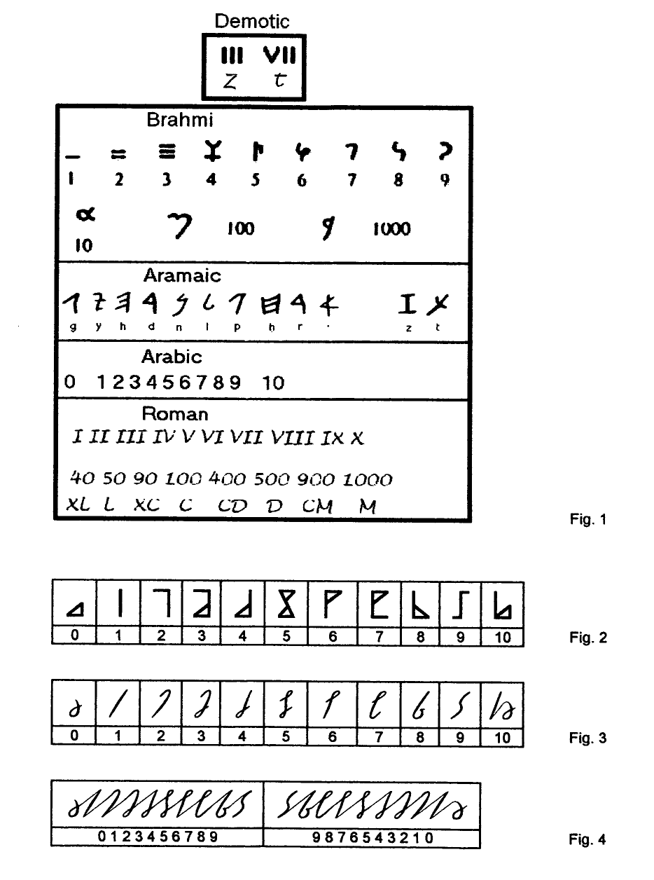

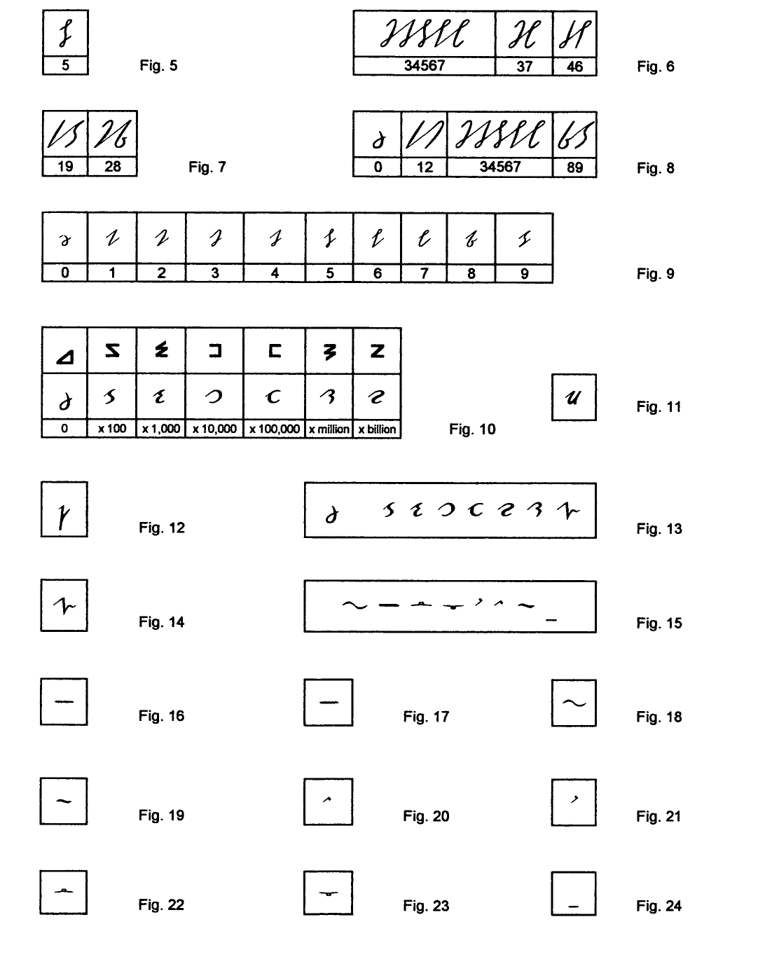

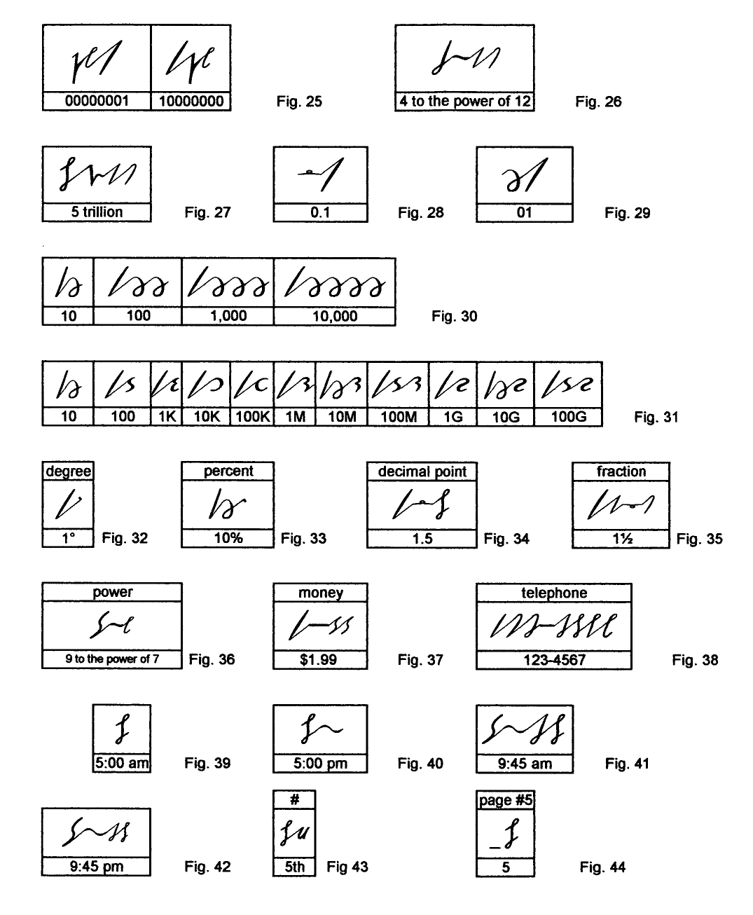

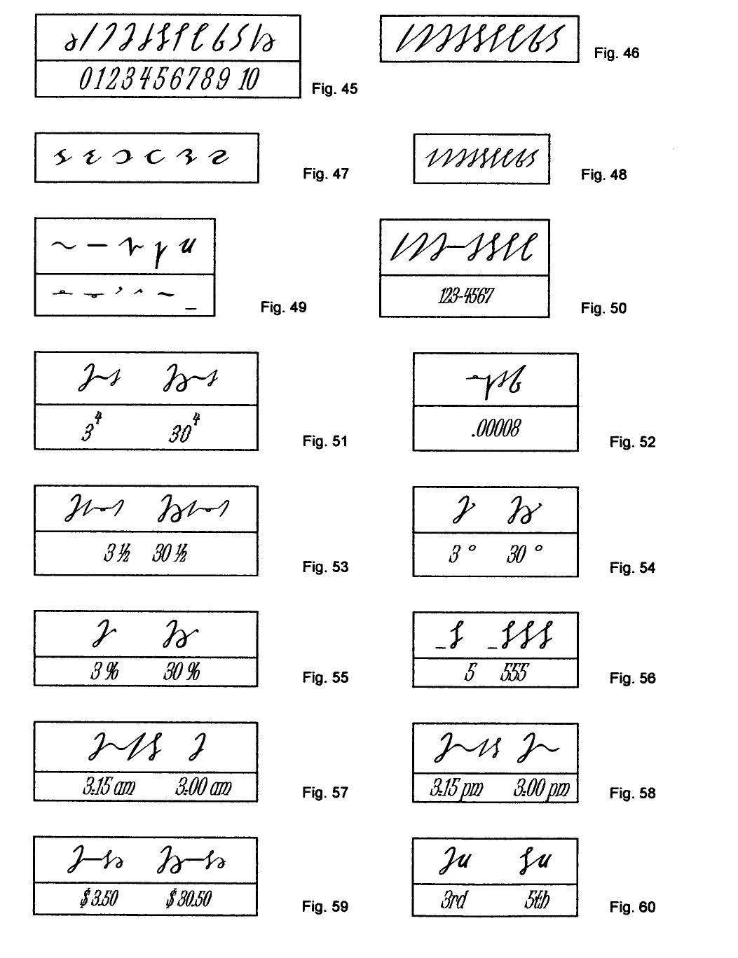

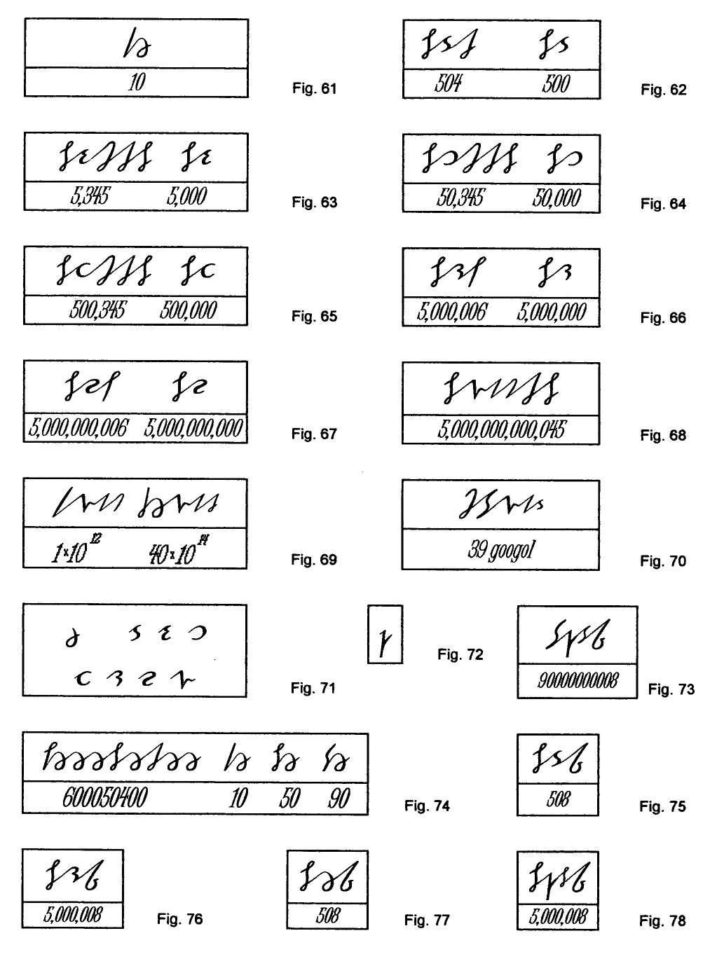

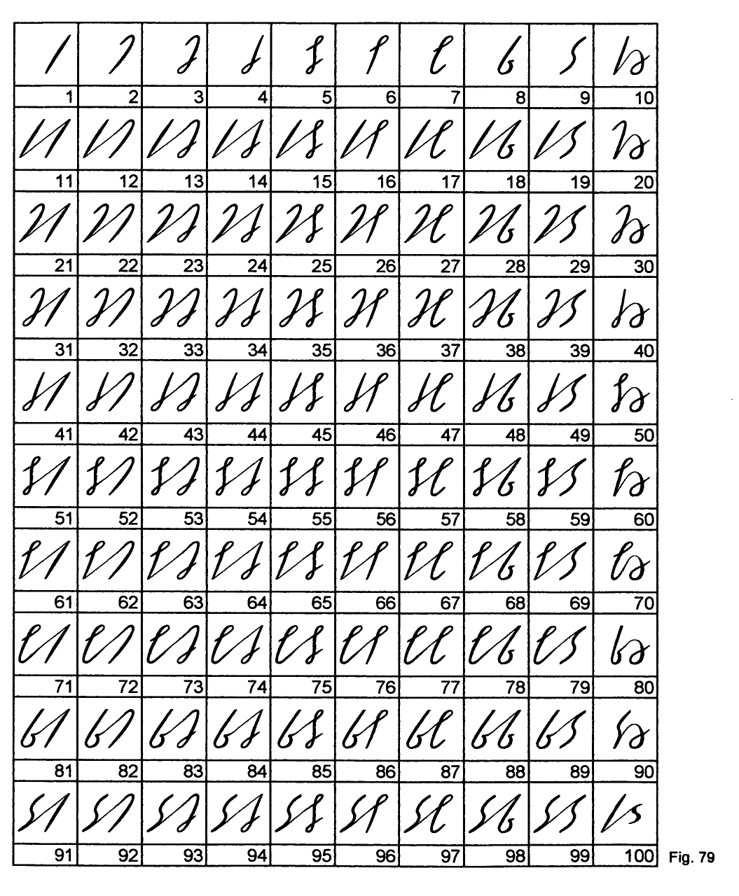

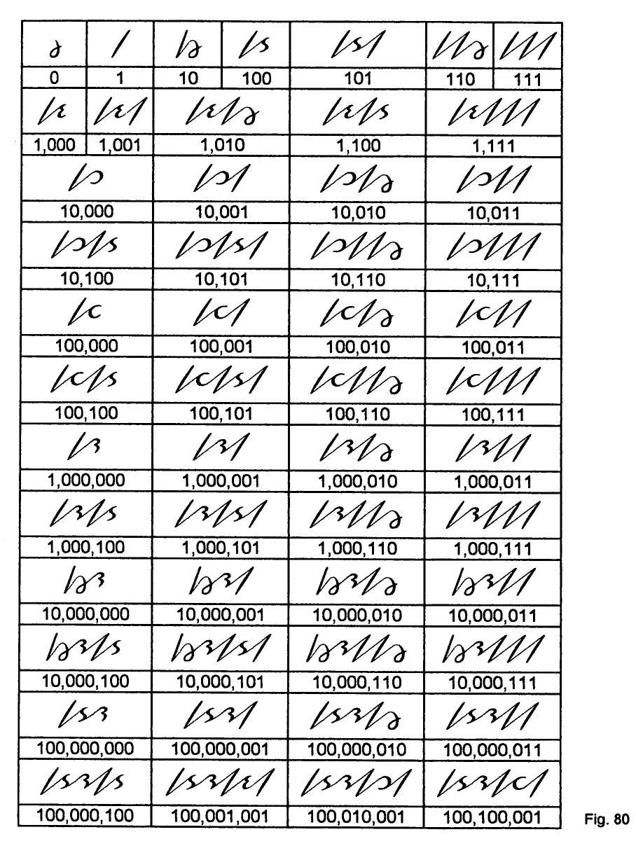

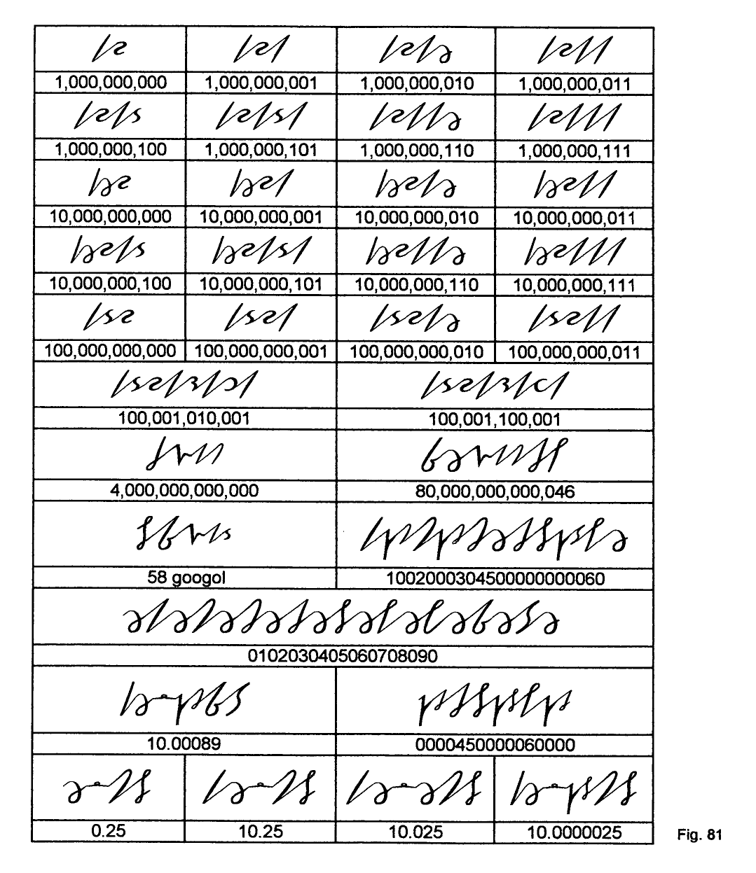

Combinations of numbers

### DETAILED DESCRIPTION OF THE INVENTION

In the past, different numeration systems have been established for use; ancient numerals, such as Arabic and Roman, have been practiced even in the present times without any change There have also been many forms of shorthand writing. However, by adopting this new version and system, there will be a convenient and more efficient use of time on diversely angled levels which today's and in the future-to-come society needs. Numerals and attachments can be written in different ways: separately, conjunctly, and in print. Special additional signs for percentage, temperature, telephone numbers, pecuniary sums, ordinal numbers, and etc. completely simplify writing performance and their suitable symbols. The difference between other numeration systems and the one being introduced is the simplification of numbers, their flexibility, and universality.

1. I claim a form of numeration system created in a different and distinguished appearance in which its individual and conjoined flowing cursive writing allows compressing the amount of zeroes in great values through conveniently comprehensive symbols and can be useful not only in this day and age but for generations to come.
